(19) United States
(12) Patent Application Publication
(10) Pub. No.: US 2013/0117701 A1
(43) Pub. Date: May 9, 2013

(54) System and Method for Coordinating a Multi-User Internet-Based Appointment Scheduler for Fashion and Related Arts

(71) Applicant: Joseph I. Evans, II, Miami, FL (US)

(72) Inventor: Joseph I. Evans, II, Miami, FL (US)

(21) Appl. No.: 13/662,325

(22) Filed: Oct. 26, 2012

Related U.S. Application Data
(60) Provisional application No. 61/551,586, filed on Oct. 26, 2011.

(51) Int. Cl. G06F 3/0484

(52) U.S. Cl. CPC G06F 3/0484
USPC 715/771

(57) ABSTRACT

A computer network having software executing in an associated storage medium and related method, the computer network comprising a graphical user interface with the software. A member profile management interface has a dialogue for a member to create a member profile wherein the member inputs personal attributes. A project management interface has a dialogue for a project manager to create a project wherein the project manager inputs project details. A graphical displays a member's availability. A project view interface allows a member to view project details. A manager search interface allows a project manager to search for project employee candidates. A member search interface allows a member to search for a project. A booking request interface allows the project manager to request a member to accept employment for a project. A messaging interface with the software allows user's of the system to communicate with other users and project managers.

### CROSS-REFERENCE TO RELATED APPLICATION

This application seeks priority to U.S. Provisional Patent Application Ser. No. 61/551,586 filed on Oct. 26, 2011 entitled “System and Method for Coordinating a Multi-User Internet-Based Appointment Scheduler for the Arts and Modeling Industry” the contents of which are incorporated by reference herein.

### FIELD OF INVENTION

The present invention generally relates to calendars for scheduling events, and in particular to an internet- and mobile-based system and method for coordinating a multiple user calendaring system to coordinate professional members of the related modeling, photography, visual arts, performing arts, and computer graphic industries.

### BACKGROUND

The visual, performing arts, and fashion arts fields are faced with the continuing difficulty of coordinating talent and employee schedules with the schedules of project managers as well as other professionals in the field. The fast-paced fashion industry, for example, often requires that photographers schedule photography shoots with little advance notice, so waiting for a response regarding a model's time availability is impractical and costly.

There is a need in the industry for a calendar and scheduling system that alleviates these communication problems and does so rapidly and accurately.

### SUMMARY

The present invention is directed to an online system and method which allows members of an online member-based network to schedule appointments in real-time and to integrate the system with mobile networks. In particular, this system and method allows project managers to search for suitable professionals using relevant criteria, book time with chosen professionals, allow professionals to accept or deny bookings, and update both internet-based and mobile-based scheduling calendars for all parties involved in the booking. A project manager can instantly see available dates and times of professionals that are members of the online system and therefore bypass telephone scheduling, greatly reducing response time and unnecessary conflicts related to the booking process.

Embodiments include, inter alia, an internet web site and integrated mobile applications. The system displays a scheduling calendar for professional models and for photographers (members of the scheduling network), and provides a mechanism to create electronic bookings that automatically notify the parties involved in the booking when a photo shoot is scheduled and booked. The photographer may search the network for appropriate models based on relevant features that are entered into a user interface. A photographer may also send out invitations to a number of potential models, and the models may respond, accepting a booking, the system automatically notifying the photographer of a booking and also populating a calendar entry.

The invention particularly contemplates a networked storage medium having executable software to perform a method of mediating communication and bookings between project managers and members of the network. The method comprises providing a graphical user interface with the software, providing a member profile management interface with the graphical user interface comprising a dialogue for a member to create a member profile; providing a dialogue with the member profile management interface for a member to input personal attributes; providing a project management interface with the graphical user interface comprising a dialogue for a project manager to create a project; providing a dialogue with the project management interface for a project manager to input project details; providing a graphical calendar with the member profile, wherein the member's availability is displayed in the calendar; automatically updating the calendar upon change of the member's availability; allowing a member to view project details; providing a manager search interface with the graphical user interface for a project manager to search for project employee candidates; providing a member search interface with the graphical user interface for a member to search for a project; providing a booking request interface with the graphical user interface wherein a project manager can request employment for a project by a member; and providing a messaging interface with the software that allows a user of the system to communicate with at least one of another user of the system and a project manager.

In a related embodiment, the invention contemplates a networked storage medium having executable software to perform a method comprising: accessing a network through a graphical user interface of software on a computing device; creating a user profile accessible to a user of the software, the user profile comprising at least one of a member name, member gender, member age, member ethnicity, member height, member eye color, member experience, member hair color, and members health information; receiving a booking request through the graphical user interface from a project manager having access to the network; receiving details of the booking request in a project view interface of the graphical user interface, the details of employment comprising a name of the project, a name of the project manager, a project location, a project time, a project description, a list of booking requests sent; responding to the booking request using a dialogue with the graphical user interface; and receiving an option to book travel arrangements through the user interface. The method further comprises the step of electronically receiving payment through a transaction initiated with the software.

The invention also contemplates a computer network having software executing in an associated storage medium. The computer network comprises a graphical user interface with the software. A member profile management interface with the graphical user interface has a dialogue for a member to create a member profile. Additionally, it has a dialogue for a member to input personal attributes associated with the member profile. Such attributes include, without limitation, the member name, member gender, member age, member ethnicity, member height, member eye color, member experience, member hair color, and members health information such as sexually transmitted disease test results. The member profile may also included member photographs, member videos, and the member's resume.

A project management interface with the graphical user interface has a dialogue for a project manager to create a project. Additionally, the project management interface has a dialogue for a project manager to input project details. Such details include, without limitation, the name of the project, the name of the project manager, the project location, the project time, and the project description. A project view interface with the graphical user interface provides the ability for a member to view such project details. The project manager is also presented a status of all booking requests sent from the booking request interface. Additionally, the project view interface displays all users whom have accepted a request for employment for a project.

A graphical calendar is also included with the member profile, wherein a member's availability is displayed in the calendar. The calendar automatically updates upon a change of the member's availability.

A manager search interface with the graphical user interface provides the ability for a project manager to search for project employee candidates. This interface provides the ability for a member to search for a project. This interface uses logic to limit search results based on a searcher's desired member personal attributes.

A booking request interface resides with the graphical user interface wherein a project manager may request employment for a particular project by a member. A dialogue with the user interface prompts for acceptance of a booking request sent to the member. A notification with the user interface is delivered to the project manager upon the member's acceptance of a booking request.

Additionally, a messaging interface with the software allows the user of the system to communicate with other users of the system and project managers.

An airfare reservation interface with the project view interface allows a member to book airfare to a location proximate a location of the project. Similarly, a hotel reservation interface with the project view interface allows a member to book a hotel reservation in a location proximate a location of the project.

### BRIEF DESCRIPTION OF DRAWINGS

For a fuller understanding of the invention, reference is made to the following detailed description, taken in connection with the accompanying drawings and photographs illustrating various embodiments of the present invention, in which:

FIG. 1 is a flow chart illustrating an embodiment of the scheduling system according to the teachings of the present invention;

FIG. 2 illustrates one embodiment of a project management interface;

FIG. 3 illustrates one embodiment of a member profile interface;

FIG. 4 illustrates one embodiment of a booking request interface; and

FIG. 4 illustrates one embodiment of a booking request manager interface.

### DETAILED DESCRIPTION OF EMBODIMENTS

The present invention will now be described more fully with reference to the accompanying drawings in which alternate embodiments of the invention are shown and described. It is to be understood that the invention may be embodied in many different forms and should not be construed as limited to the illustrated embodiments set forth herein. Rather, these embodiments are provided so that this disclosure may be thorough and complete, and will convey the scope of the invention to those skilled in the art.

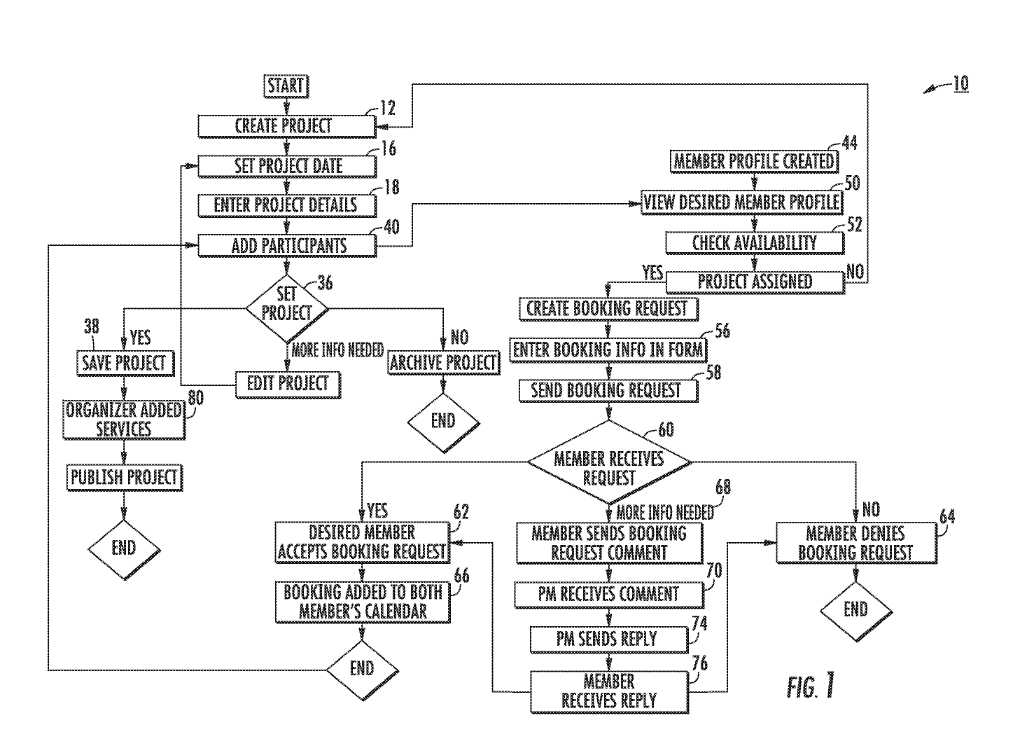

One embodiment of the present invention includes a networked storage medium having executable software for an online system and method that allows members of an online website network to manage photographic, modeling, acting, and general fashion and performing arts projects. With reference initially to FIG. 1, the method of creating, managing, and interacting with the project management network 10 is illustrated.

The system illustratively includes a server, and at least one computing device communicating with the server. In an illustrative embodiment, a member having a computing device communicates with a project manager having a computing device, with or without an intermediary server. The computing device includes a display, and an input device cooperating therewith. The computing device receives data from and transmits data to the server. A user interface with the display is a visual representation and control panel, means for observing audio/video/text sent from the network or other member's or project manager's computing devices, and means for engaging in commercial transactions. In one embodiment, a member logs onto a web-based member network.

Content provided to computing devices by the server includes any combination of text, audio, video, user Interface (UI), and UI controls. In the case of a web browser, the content would be a page of HTML, or similar language, having streaming video elements. The UI may include links to other pages on the site and perhaps links to other sites, as well as controls viewing embedded multimedia files. This content operates as it normally would on a display. The content also includes a tracking cookie. This cookie is stored in the display system and data therein is retrieved at will by the server. Other methods for tracking members could be employed such as a customer's login to the website, a unique identifier connected to the hardware, or other data that uniquely identifies the member.

The online system is not limited to an online web site, but may also be integrated with mobile networks through mobile-optimized internet browsing portals or via platform-specific (e.g. iOS, Android, Blackberry® OS, Windows Mobile, etc.) mobile apps.

With reference again to FIG. 1, a project is created 12, typically by a project manager. A project is, for example, without limitation, a photographic, modeling, acting, and general fashion and performing arts project. Such projects typically require a multitude of employees, such as photographers, models, actors, light technicians, catering personnel, makeup artists, and any other participant classes known in the arts.

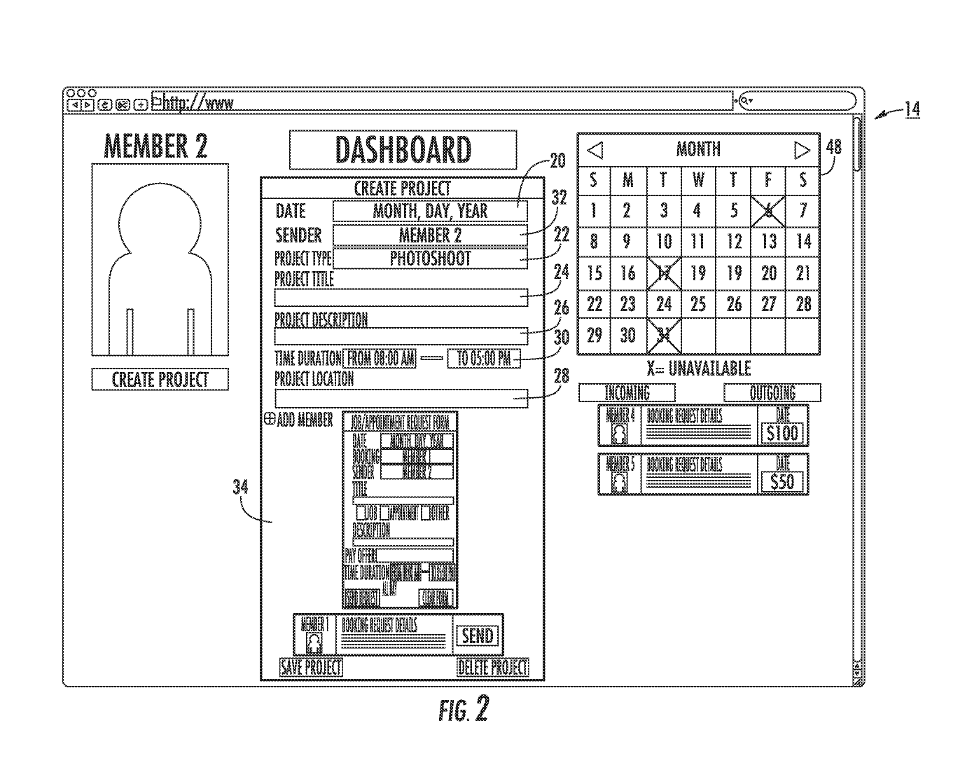

FIGS. 1 and 2 illustrate a project management interface 14 (PMI). The PMI 14 is a portion of a graphical user interface of the software. The PMI 14 is the interface wherein a project manager creates a project 12, sets the project date 16, and enters relevant project details 18. The project details 18 include the project date 16, project type 22, project title 24, project description 26, project location 28, project duration 30, and identification of project manager 32. These project details 18 are entered into a create-project dialogue 34 with the PMI 14. Other project details 18 may include information about venues such as studio hours of operation, photographs of the venue, listing of amenities, listing of model accommodations, listing of available equipment, and any other salient information useful to describe the venue known in the art. Similarly, information specific for makeup artists, hair stylists, directors, photo retouchers, actors, and any other member class may be compiled.

Once a project is finalized 36, the project is saved 38, and project details 18 are viewable by members. The project manager may then invite 40 members of the network to participate in the project.

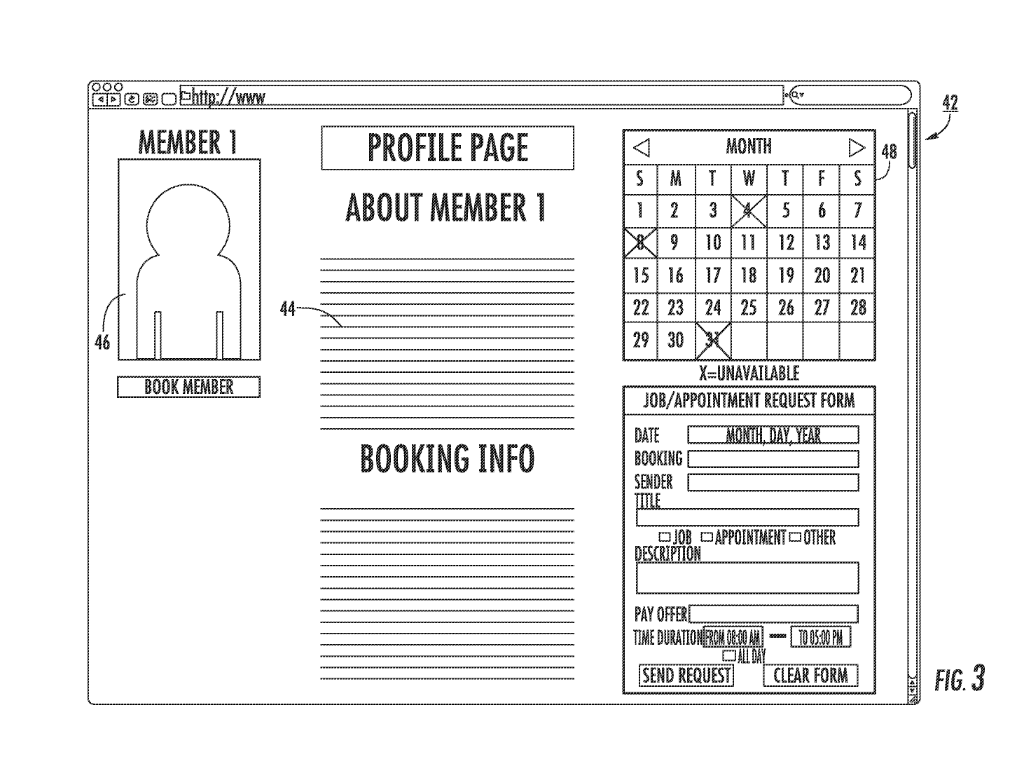

Turning to FIG. 3, a member profile 42 that is created using a member profile management interface 43 (MPMI) provides an interface for creating a member profile 42. A member must create a member profile 42 for access to the appointment scheduling, calendaring, communication, and any other functionality of the system. The MPMI 43 has a dialogue to input a member's personal attributes 44 including, without limitation, the name, gender, age, race, ethnicity, height, weight, eye color, experience level, hair color, and health information. Additionally, multimedia files 46 such as photographs, member videos, and the member's resume can be uploaded using the MPMI 43. The personal attributes 44 and multimedia files 46 are presented on a user's member profile 42.

Other data that may be used to create a member profile page 42 include: demographic data such as marital status, income, educational information, religion, or any other personal information; social media data such as account login information, handles or usernames, avatars, social network preferences, or any other information related to social media use and accounts; mobile and communication data such as short message service (SMS) contact information, geolocation data, voice over internet protocol (VoIP) information, or any other information related to mobile communications, communication technology, and related devices; payment system such as credit card information or online payment system information or direct access to financial institutions such as PayPal™ or Google® checkout, credit card accounts, bank accounts, credit card processors, electronic banking, or any other financial information or access.

Since the invention is directed towards the photographic, modeling, acting, and general fashion and performing arts projects community, member profiles 42 may contain attributes that are directed to the fields of, without limitation, hair stylists, wardrobe stylists, makeup stylists, fashion designers, artists, painters, directors, producers, dancers, singers, sculptors, photo retouchers, web designers, graphic artists, agents, publishers, venues, studios, and casting directors.

For example, a photographer's personal attributes 44 and multimedia files 46 include information such as portfolio examples, photographic equipment proficiencies (e.g. related to cameras, lighting, lenses, darkroom technology, printer technology), software and image processing proficiencies, and any other salient information known in the art. For models, personal attributes 44 and multimedia files 46 include information such as headshot images, portfolio examples, physical characteristics (e.g. hair color, eye color, measurements, dress size, shoe size), agency affiliation, show experience, advertising experience, video experience, and any other pertinent information known in the art. It should be noted that animals can also be represented with a member account, and that an animal model profile class will also be implemented comprising industry-specific data for animal models (e.g. coat color, eye color, measurements, experience, etc.).

Member profile information, calendaring information, communications between users, uploaded content, and any other relevant information known in the art are stored preferably on computer servers in at least one of a computer file and database.

An electronic networkable calendaring function is part of the software. A calendar instance 48 is present with each member profile 42 and PMI 14. The graphical user interface allows members and project managers to enter a calendaring dialogue to edit, add, or remove calendar entries.

Calendar instances 48 are populated with appointments that members and project managers have created or approved. Each user profile and project contains a calendar instance 48, yet other users and project managers have access to view each other member's calendar instance 48. For example, when a member has an appointment scheduled on their calendar instance 48, project managers can see which time blocks are scheduled for that member. This allows project managers to know the schedules for members, and members to know the schedules for projects. It is, however, an option for members or project managers to make certain portions or entire calendars private. Specific members, groups, or classes of members may have restricted permission to view another user's calendar based on that member's permission preferences. Changes made to calendar instances 48 update in real-time and these changes integrate the system with calendar applications for computing devices, mobile devices, and computer and mobile networks.

Calendaring is programmed to synchronize with both computing applications (e.g. Microsoft® Outlook) and online applications (e.g. Google® calendar), and mobile applications so that changes and updates to an appointment are automatically changed in a user's extra-site calendar applications, in real-time. The system may also communicate with social networking sites, employ notifications, status updates, and communications to outside networks. The system is also optionally accessible in outside websites (i.e. social networking platforms, personal websites, blogs, etc.) and in mobile computing application platforms.

A calendaring algorithm computes time zone differences and notifies users in differing time zones of such a differential. When tied to a mobile device or application, the user has the option for time zone differentials to self-adjust based on changes in geolocation (e.g. while traveling and a mobile device is brought from one time zone to another time zone).

A project manager searches for member employee candidates based on specific criteria in a manager search interface that is a feature of the graphical user interface, and then browses the query results. The project manager then views desired member profiles 42 associated with the search results. Member availability is checked 52 in the calendar instance 48 associated with that member's member profile 42. Alternatively, calendar availability can be part of the limiting search terms in the initial query. For example, without limitation, a photographer may search for a model by any of the attributes entered in the user profile, and models meeting the requirements of the query are displayed. The display may be a calendar interface, a textual list, or a graphical representation. The photographer checks the availability of models meeting selected query requirements. These models may be subsequently sent a booking request for a photo shoot. Alternatively, as part of the search query, a photographer may specify particular time slots such that only models not booked at that particular time are returned in search results.

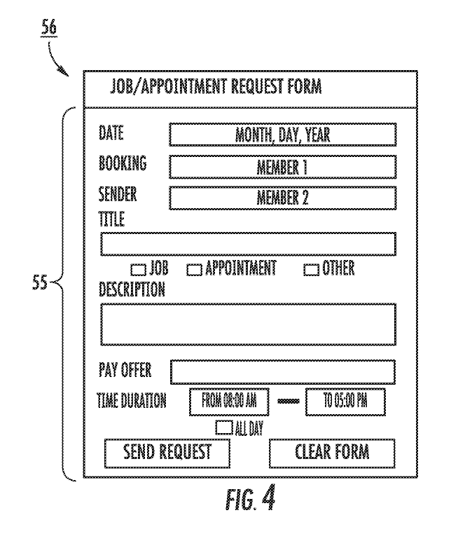

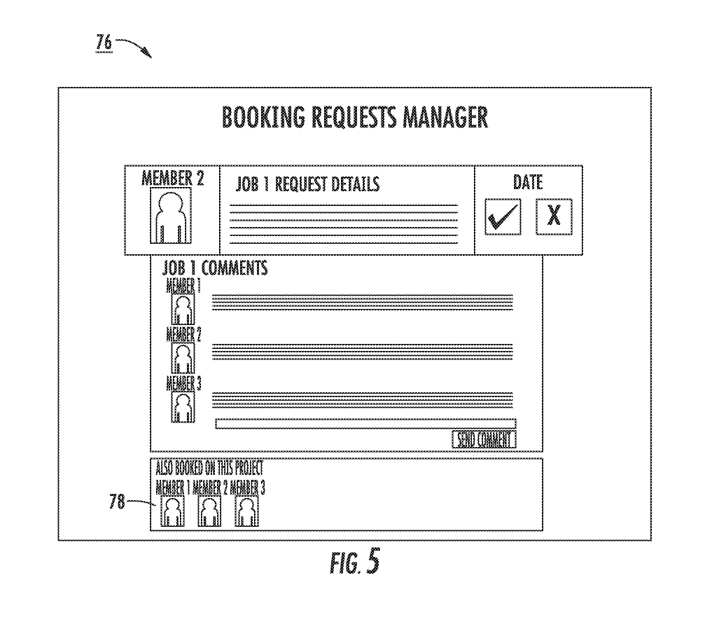

Turning now to FIGS. 1 and 4, a project manager enters 54 booking information 55 in a booking request interface 56, to send 58 an employment (booking) request to desired members. A booking request may also be sent to email accounts, through SMS, to mobile devices, or any other communications means known in the art. Members receive 60 the booking request, and can either accept 62 or deny 64 the request. Responding to a request by either accepting or denying the request 62, 64 may also be effectuated through the utilization of email, SMS, mobile devices, or any other communications means known in the art. If the recipient member accepts 62 the booking request, the booking is added to the calendar 66 of both the project and member calendar instances 48. Users of the system, prior to accepting a booking request, have the option to send messages, questions, and/or commentary to other members. If more information is desired 68 by the member, the member sends a booking request comment 70 which is received by the project manager 72. The project manager 72 then sends a reply which is received 74 by the member.

As illustrated by FIG. 5, a booking request manager is the graphical interface by which project managers may notify members of a booking request. Multiple members may be simultaneously notified of an available project. In this case, more members can be notified than are required for a specific project. In this scenario, each member receives 60 an invitation to accept an appointment for a photo shoot. The first member or members to accept the available time slots are displayed in a confirmed booking section 78 of the booking request manager 76, and are scheduled an available time slot, displayed in the confirmed booking section 78. If all of the available time slots are accepted, a notification is automatically sent to the remainder of the non-accepting members originally notified by the project manager indicating that all available appointments are fulfilled, and that the offer to accept the invitation is automatically rescinded. For the members that accept the invitation, both the member's and the project's calendar is populated with the appointment. Notifications related to the bookings are sent to email accounts, through SMS, mobile devices, or any other communications means known in the art.

Members may communicate with other members and also project managers using a messaging interface that is part of the software. Messages are sent between members, and may comprise email, SMS, private system-based instant messages, and any other electronic communication known in the art. A member sends a communication, and another member receives the communication. The receiving member has the option to send a reply message.

Any member can create a project. A project manager (any member that creates a project) can post an event and the calendaring system will be utilized to schedule such an event.

With reference again to FIG. 1, the project manager may provide organizer added services 80 to a member that accepts employment with a project. Organizer added services 80 are additional services that compliment a project such as travel arrangements and payment services. For example, a project manager enters destination details so airfare, hotel reservations, and car rental information are automatically presented to a member based upon that member's location. Therefore, the date, time, originating location, destination location, frequent flier mile numbers, and any other relevant travel information automatically populates a travel search engine. Alternatively, this information is transmitted to a third party travel web site.

Organizer added services 80 also include interfaces for the purchase of insurance, providing legal documents, and permitting. For example, the legal document interface provides the downloading of employment contracts, venue contracts, non-disclosure agreements, and other lawyer-created documents relevant to the project. Additionally, a permitting interface provides access to secure permits for venues, employment, pyrotechnics, and related permits necessary for a project. Again, these added services are provided as part of the system, or are linked to networks or websites external to the system described herein.

In one embodiment of the invention, photographs, video, and other multimedia files that are associated with the project are published on the system for members to view. These uploaded files ideally reflect the scope and/or results of a project and are shared in a gallery type user interface for promotion or sales purposes. These images may also be published or linked to outside networks and websites.

Many modifications and other embodiments of the invention will come to the mind of one skilled in the art having the benefit of the teachings presented in the foregoing descriptions and the associated drawings and photos. Therefore, it is to be understood that the invention is not to be limited to the specific embodiments disclosed, and that modifications and alternate embodiments are intended to be included within the scope of the claims supported by this specification.

What is claimed is:

1. A networked storage medium having executable software to perform a method, the method comprising:
providing a graphical user interface with the software;
providing a member profile management interface with the graphical user interface comprising a dialogue for a member to create a member profile;
providing a dialogue with the member profile management interface for a member to input personal attributes;
providing a project management interface with the graphical user interface comprising a dialogue for a project manager to create a project;
providing a dialogue with the project management interface for a project manager to input project details;
providing a graphical calendar with the member profile, wherein a member's availability is displayed in the calendar;
automatically updating the calendar upon a change in the member's availability;
providing a member an opportunity to view project details;
providing a manager search interface with the graphical user interface for a project manager to search for project employee candidates;
providing a member search interface with the graphical user interface for a member to search for a project;
providing an booking request interface with the graphical user interface wherein a project manager can request employment with a project by a member; and
providing a messaging interface with the software that allows a user of the system to communicate with at least one of another user of the system and a project manager.

2. The method of claim 1, further comprising the step of providing a member an opportunity to accept a booking request sent from the booking request interface.

3. The method of claim 2, further comprising the step of notifying the project manager upon acceptance by the member of the booking request sent from the booking request interface.

4. The method of claim 1, further comprising the step of providing a status interface with the project management interface wherein the project manager can view a status of all booking requests sent from the booking request interface.

5. The method of claim 1, further comprising the step of providing access to a member for viewing additional users whom have accepted a request for employment for a project.

6. The method of claim 1, further comprising the step of providing access to a member for viewing other users whom a project manager has requested employment for a project.

7. The method of claim 1, further comprising the step of providing a member an airfare reservation interface with the graphical user interface for a member to book airfare to a location proximate a location of the project.

8. The method of claim 1, further comprising the step of providing a member a hotel reservation interface with the graphical user interface for the member to book a hotel reservation in a location proximate a location of the project.

9. The method of claim 1, further comprising the step of providing a member an interface with the graphical user interface for the member to receive legal documents related to the project.

10. The method of claim 1, further comprising the step of providing a member an insurance interface with the graphical user interface for a member to purchase insurance related to the project.

11. The method of claim 1, further comprising the step of providing a payment interface with the graphical user interface for a project manager to send payment to a member.

12. The method of claim 1, further comprising the step of providing a dialogue with the member profile management interface for inputting the member's health information.

13. The method of claim 12, wherein the health information comprises sexually transmitted disease test results.

14. The method of claim 1, wherein the project details comprise at least one of a name of the project, a name of the project manager, a project location, a project time, and a project description.

15. The method of claim 1, wherein the personal attributes comprise at least one of a member name, member gender, member age, member ethnicity, member height, member eye color, member experience, member hair color, and members health information.

16. The method of claim 1, wherein the personal attributes comprise at least one of a member photograph, member video, and member resume.

17. The method of claim 1, wherein the manager search interface comprises logic to limit search results based on a searcher's desired member personal attributes.

18. A networked storage medium having executable software to perform a method, the method comprising:
accessing a network through a graphical user interface of software on a computing device;
creating a user profile accessible to a user of the software, the user profile comprising at least one of a member name, member gender, member age, member ethnicity, member height, member eye color, member experience, member hair color, and members health information;
receiving a booking request through the graphical user interface from a project manager having access to the network;
receiving details of the booking request in a project view interface of the graphical user interface, the details of booking comprising a name of the project, a name of the project manager, a project location, a project time, a project description, and a list of booking requests sent;
responding to the booking request using a dialogue with the graphical user interface; and
receiving an option to book travel arrangements through the user interface.

19. The method of claim 18, further comprising the step of electronically receiving payment through a transaction initiated with the software.

20. A computer network having software executing in an associated storage medium, the computer network comprising:
a graphical user interface with the software;
a member profile management interface with the graphical user interface comprising a dialogue for a member to create a member profile;
a dialogue with the member profile management interface for a member to input personal attributes;
a project management interface with the graphical user interface comprising a dialogue for a project manager to create a project;
a dialogue with the project management interface for a project manager to input project details;
a graphical calendar with the member profile, wherein a member's availability is displayed in the calendar;
a project view interface with the graphical user interface providing the ability for a member to view project details;
a manager search interface with the graphical user interface providing the ability for a project manager to search for project candidates;
a member search interface with the graphical user interface providing the ability for a member to search for a project;
a booking request interface with the graphical user interface wherein a project manager provides the ability for the project manager to request employment for a project by a member; and
a messaging interface with the software that allows a user of the system to communicate with at least one of another user of the system and a project manager.

21. The computer network of claim 20, wherein the calendar automatically updates upon a change of the member's availability.

22. The computer network of claim 20, further comprising a dialogue with the user interface to prompt acceptance of a booking request sent from the booking request interface.

23. The computer network of claim 20, further comprising a notification with the user interface delivered to the project manager upon acceptance by the member of a booking request.

24. The computer network of claim 20, further comprising a status interface with the project management interface wherein the project manager is presented a status of all booking requests sent from the booking request interface.

25. The computer network of claim 20, wherein the project view interface displays all users whom have accepted a request for employment for a project.

26. The computer network of claim 20, further comprising an airfare reservation interface with the project view interface for a member to book airfare to a location proximate a location of the project.

27. The computer network of claim 20, further comprising an interface for the member to receive legal documents related to the project.

28. The computer network of claim 20, further comprising an interface for the member to purchase insurance related to the project.

29. The computer network of claim 20, further comprising a hotel reservation interface with the project view interface for a member to book a hotel reservation in a location proximate a location of the project.

30. The computer network of claim 20, further comprising a payment interface with the graphical user interface for a project manager to send payment to a member.

31. The computer network of claim 20, further comprising a dialogue with the member profile management interface for inputting the member's health information.

32. The computer network of claim 31, wherein the health information comprises sexually transmitted disease test results.

33. The computer network of claim 20, wherein the project details comprise at least one of a name of the project, a name of the project manager, a project location, a project time, and a project description.

34. The computer network of claim 20, wherein the personal attributes comprise at least one of a member name, member gender, member age, member ethnicity, member height, member eye color, member experience, member hair color, and members health information.

35. The computer network of claim 20, wherein the personal attributes comprise at least one of a member photograph, member video, and member resume.

36. The computer network of claim 20, wherein the manager search interface comprises logic to limit search results based on a searcher's desired members personal attributes.
